(19) United States
(12) Patent Application Publication
(10) Pub. No.: US 2023/0222232 A1
(43) Pub. Date: Jul. 13, 2023

(54) Method and System to Implement Multi-Factor Authorization

(71) Applicant: DevRev, Inc., Palo Alto, CA (US)

(72) Inventors: Steven POITRAS, Austin, TX (US); Brian BYRNE, Issaquah, WA (US); Venkata Vamsi Krishna Kothuri, San Jose, CA (US); Xiuhui Ming, Austin, TX (US)

(21) Appl. No.: 18/069,978

(22) Filed: Dec. 21, 2022

Related U.S. Application Data
(60) Provisional application No. 63/292,106, filed on Dec. 21, 2021.

(51) Int. Cl. G06F 21/60

(52) U.S. Cl. CPC G06F 21/604; G06F 2221/2113; G06F 2221/2141

(57) ABSTRACT

Disclosed is an approach for dynamically applying roles and access levels to an actor based at least in part upon a set of conditions an object should meet for the role to be assumed. The approach may dynamically determine privileges based at least in part upon API endpoints and operations. A multi-factor approach may be taken for determining authorization based at least in part upon conditions, attributes, and policy.

### CROSS-REFERENCE TO RELATED APPLICATIONS

The present application claims the benefit of priority to U.S. Provisional Application No. 63/292,106, filed on Dec. 21, 2021, which is hereby incorporated by reference in its entirety.

### BACKGROUND

The present disclosure describes a new approach to implement authorization in computing systems.

Authorization and authentication are two different aspects of computing that pertain to access within a computing system. Authentication is the process used to authenticate who an actor says that they are, e.g., to obtain access to a resource. Authorization controls what the actor is allowed to do or see once they have been authenticated.

Traditional approaches like role-based access control (RBAC), attribute-based access control (ABAC) and policy-based access control (PBAC) have been used for access control. However, these approaches are now antiquated, since these approaches are typically statically defined and are often global to the system. The users' roles, positions, and focuses are constantly in flux and thus there is a need to build a system that embraces this dynamic nature and provides the optimal balance between unrestricted development while providing the strongest possible security.

In addition, traditional authorization does not account for things that are going on in the business or the dynamic nature of objects which are constantly changing. For example, if a user has access to perform X, they can technically do that no matter what is going on in the business (e.g., security breach). Similarly, if the object the user is performing operations on changes, this traditionally has no impact on the authorization decision. The traditional policy does not know about occurrences outside its world of privileges, policies, and operations.

Therefore, there is a need for an improved approach for implementing access control and authorizations in a computing system.

### SUMMARY

Some embodiments of the invention provide an approach for dynamically applying roles and access levels to an actor based at least in part upon a set of conditions an object should meet for the role to be assumed. An embodiment may dynamically determine privileges based at least in part upon API endpoints and operations. A multi-factor approach may be taken for determining authorization based at least in part upon conditions, attributes, and policy.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1A shows a system that is implemented according to some embodiments of the invention.

FIG. 1B shows a high-level flow chart of the flow leveraged by the system.

FIG. 2 shows a high-level view of an approach according to some embodiments.

FIG. 3 shows a more detailed breakdown of the inventive approach according to some embodiments.

FIG. 4 shows a high-level view of some concepts according to some embodiments.

FIG. 5 shows the complete relationship from an actor to the roles on object(s) and entitlements they may have.

FIG. 6A shows the relationship between a feature (part), the privileges it provides, how those may be teamed with a role and mapped to object roles.

FIG. 6B shows a structure that can be used to define a sample role structure.

FIG. 6C shows how roles map to default privileges.

FIG. 6D shows how conditions can be used to set both the applicable role, access level, and available object types.

FIG. 7A shows a sample privilege schema.

FIG. 7B shows the reference endpoint to privilege structure.

FIG. 8 shows an example approach to implement a policy/rule engine.

FIG. 9 is a block diagram of an illustrative computing system suitable for implementing an embodiment of the present invention.

### DETAILED DESCRIPTION

Various embodiments will now be described in detail, which are provided as illustrative examples of the invention so as to enable those skilled in the art to practice the invention. Notably, the figures and the examples below are not meant to limit the scope of the present invention. Where certain elements of the present invention may be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Further, various embodiments encompass present and future known equivalents to the components referred to herein by way of illustration.

Some embodiments of the invention provide an approach for dynamically applying roles and access levels to an actor based at least in part upon a set of conditions an object should meet for the role to be assumed.

When one looks at what issues may occur in the business, there are events and situations such as security breaches, corporate closing, end of quarters, etc. that may impact a policy's decision to authorize certain operations or not. For example, if there is a security breach or notice of anomalous/malicious behavior from a user, there may be a desire to temporarily limit what that user is authorized to do while investigating what is going on (the change in behavior may be valid). It should therefore be considered that static approaches to manage such situations do not work, since changes may occur on a constant basis.

For example, when managing access (e.g., orders or opportunities in a CRM (customer relations management), accounting, or database system), the system may want to restrict read access during closing of the books or financial reporting periods. By allowing the policy to account for these environmental factors, some embodiments can enhance the policy to make a more well-informed decision based upon context versus static definition.

There are numerous reasons for the importance of authorization to a system. For example, with respect to user experience, it is beneficial to tailor the experience to who the actor is; rather than allowing the user to try to perform an operation they are not authorized to perform, the system can either grey out the operation or minimize its appearance.

This minimizes the number of errors the user may receive for invalid operations by not allowing them to perform an un-allowed operation in the first place. In some embodiments, roles are contextual based at least in part upon the object in context. For example, support engineers may be able to launch a screen share on tickets, but engineers may not be able to. Triagers (e.g., support or administrative personnel) will be able to “accept” a ticket on their part, but a developer may not be able to, etc.

With respect to data privacy, this topic is a quintessential item for any multi-tenant platform. It ensures an actor only gets access they are given access to and that compliance and data standards are maintained. Within an organization there may be areas that only certain roles or levels may be able to see (e.g., legal data, PII (personally identifiable information) data, etc.).

With respect to platform security, authorization is not just critical for managing external actor authorization, it is also just as critical internal to the system. Services communicating with each other should not be given carte blanche to interact with other services. All communication between services should run through the same authorization which controls and limits what, when and how services can communicate.

To achieve truly dynamic authorization, embodiments of the invention have taken a new approach that provides a much more comprehensive approach to authorization.

To do this, some embodiments implement a system and method that takes the following factors into decision-making, achieving what is termed ‘Multi-Factor Authorization’ (MFZ) comprising some or all of: (a) Policy (company defined, regulatory and compliance); (b) Time (when, blackout periods); (c) Attribute (user and object based); (d) Context (events, anomalies, when, how, where); (e) Entitlements (how much they are allowed to do); and/or (f) Role (global and object based).

Some embodiments provide an approach for dynamically applying roles and access levels to an actor based at least in part upon a set of conditions an object should meet for the role to be assumed. An embodiment may dynamically determine privileges based at least in part upon API endpoints and operations. A multi-factor approach may be taken for determining authorization based at least in part upon conditions, attributes, and policies.

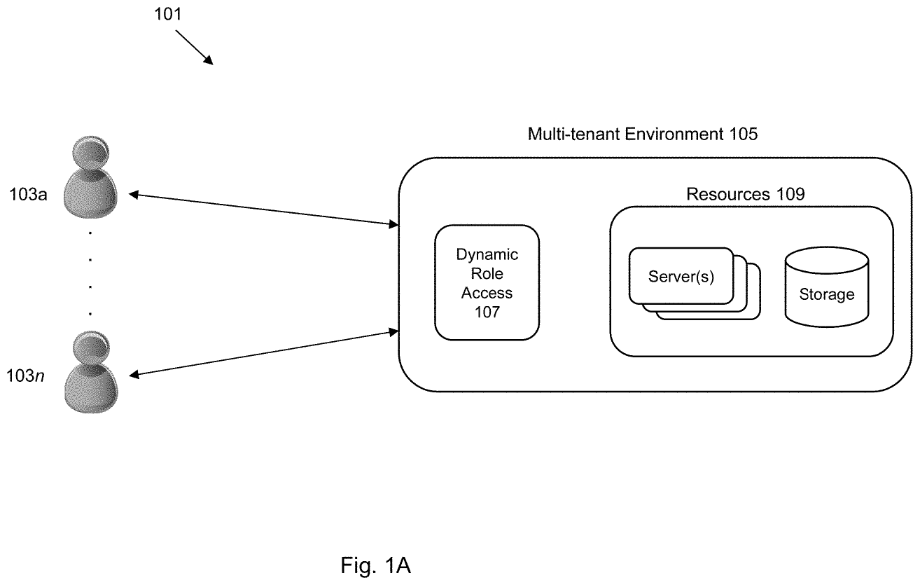

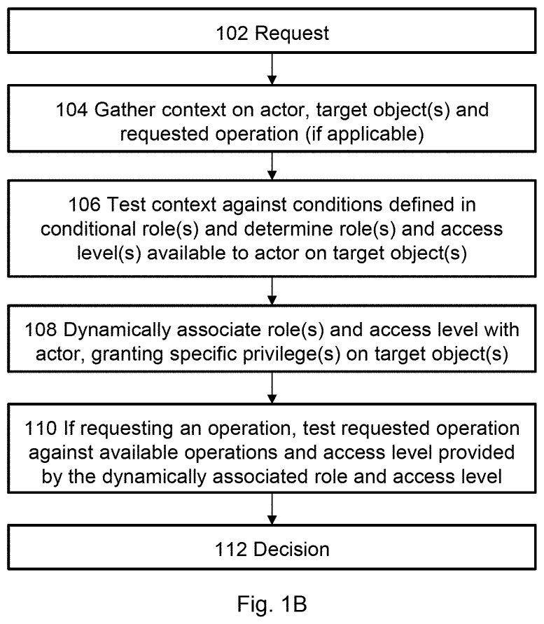

FIG. 1A shows a system 101 that is implemented according to some embodiments of the invention. The system 101 may include a multi-tenant computing system 105 (e.g., a cloud-based computing environment having resources 109) that may be accessed by one or more actors 103a-n. In some embodiments, by default, no roles are statically given to an actor of the system. Instead, a dynamic role access mechanisms 107 is used to dynamically assign roles to the actors that seek to access a resource within the system.

One can define conditions that object(s) match for the actor to temporarily implement that role (if applicable). If the object matches the condition(s), the actor can implement that role which enables them to perform certain operations (a “role” provides a set of available privileges). This differs from traditional RBAC which statically defines roles and associations with objects, or ABAC which uses an object's attributes to allow an operation to be performed, but does not use attributes to assign roles dynamically.

Since roles are not statically assigned and an object is evaluated on each request, a role may be applicable in one object state. However, if the state changes (e.g., an attribute is changed) the role may no longer be applicable since the conditions are no longer met. Given the dynamic nature of this approach, this can also be leveraged to not only assign roles but also restrict field/attribute level access.

With these conditions, one may define multiple conditions that provide for the same role/set of privileges but may restrict which attributes are readable/writable. For example, conditions may be defined that allow the actor to read an amount field, however if that value was above a certain level automatically restrict that attribute from being visible while the role remains the same (see access levels).

Traditional authorization systems will allow actors to perform operations so long as they have the privilege to do so. However, some embodiments can be implemented to authorize an actor to perform an operation based at least in part upon some or all of the following evaluating to true: (a) They have the privilege to perform the requested operation; (b) They have the necessary entitlement to perform the requested operation (e.g., entitlements may place restrictions on the number of certain operations within a specified window); and/or (c) There are no restrictions/overrides (e.g., time, QoS (quality of service), anomalies, etc.).

Since the applicability of roles is determined based at least in part upon conditions matching to a target object, this provides the ability to be non-restrictive (e.g., null conditions), partly restrictive (object_type=ticket) or very restrictive (object_id=999).

Privileges are dynamically generated based at least in part upon API operations that are exposed as part of the service. Since these are dynamic, this ensures the authorization is always up to date and any exposed API operation will have a corresponding privilege which may be included in roles—given the design of the policy, it can be enforced all the way from the client natively, out on the edge or as part of the platform.

It is noted that the inventive concepts disclosed herein may be applied to any type of computing system to which the invention is suited. For purposes of illustration only (and not by way of limitation unless expressly claimed as such), various embodiments may be described in the context of a system that manages discovery and lifecycle management of products, parts, or services. The typical product or service in the modern economy touches upon, inhabits, or interrelates with numerous disparate locations, devices, and/or entities that pertain to the product or service. Each of these different locations, devices, and entities may inhabit its own compartmentalized ecosystem that is distinct from—and effectively walled off from—any of the other compartmentalized ecosystems. For example, a company that develops a software product may correspond to a development environment having a set of development tools and databases that are organized and optimized for the software development process. The user of the software product may correspond to a set of computing devices, machines, or server devices upon which the software program is executing or performing work. The administrators of the software product or the systems upon which the software is located may have their own set of operational or monitoring tools that are used to administer the software of underlying systems. One or more organizations within a company may be tasked to handle customer sales or user relationships using a set of systems or tools to manage the interactions with the customers/users (e.g., using CRM systems, billing systems, etc.). Each of these ecosystems produce a stream of events that describe some activity or change in those systems. These events are unique to each ecosystem but they may reference some entities that span systems. It is important to note that the software product or service hierarchy is common across all ecosystems and the various event streams reference this common hierarchy either directly or indirectly.

A product/service management architecture in which the invention may be usefully applied can process and integrate data and events from disparate ecosystems pertaining to products or services. These embodiments address a significant problem of conventional development and customer relations management (CRM) systems, which is that developers (“dev”) are greatly isolated from their users/customers (“rev”). By removing barriers between the “Dev” side and the “Rev” side, this permits embodiments of the invention to easily connect code on the Dev side to production issues and user/customer interactions on the Rev side. This permits software development to no longer have to work across silos of different systems to meaningfully communicate and collaborate with their software users and customers. The architecture may automatically cluster events from various ecosystems into noteworthy incidents and to correlate them with entities extracted from each system. Incidents are correlated between ecosystems to classify the type of incidents and to give a coherent converged picture of the event streams coming from the various ecosystems. Noteworthy incidents are automatically converted into tickets and their severity is ascertained from the associated incidents. Tickets that reference underlying defects with the product or service are converted into issues. The issues are assigned to specific developer or service owner entities who are responsible for causing them or fixing them. In addition, the priority of the issues is determined by the scope of the associated tickets. Embodiments of the architecture operate by progressing objects within the system through a series of stages that will “funnel” the data into more meaningful sets of analyzed data as the object progress through the different stages. The raw data from the various Dev and Rev sources are likely to correspond to an extremely large volume of data, which individually by themselves may not provide enough cross-hierarchy context to be meaningful. That large volume of raw data, when analyzed in a unified way across the different hierarchies, may be used to form increasingly smaller and more meaningful sets of data that can be usefully provided to developers, users, managers, and/or any other party that can benefit from a unified cross-hierarchy look at events and data within the system. An example approach to implement this type of architecture is described in U.S. application Ser. No. 17/670,359, which is hereby incorporated by reference in its entirety. It is noted however, that the invention may be applied to other types of architectures as well, and is not limited in its scope only to an architecture to manage discovery and lifecycles of products and services unless expressly claimed as such.

FIG. 1B shows a high-level flow chart of an approach to implement some embodiments of the invention. At 102, a request may be received by the system to begin the flow. In step 104, the system gathers the necessary details on the actor (e.g., user, system, bot, service, etc.), the target object (if any) and the requested operation (if applicable). These details are inputs to determine context and evaluate what conditional roles are available. This is broken down into some or all of the following steps: (a) Get actor details—Determine conditional roles assigned to actor; (b) For each conditional role, get the list of conditions that must be true for the role and the access level available to the user; and/or (c) Get object details which will be used to validate against the conditions in the conditional roles.

In step 106, the system is now validating the object against the conditions defined in the conditional roles. If all conditions in the conditional role are satisfied with the object in focus, the role and associated access level becomes available to the user. This is broken down into some or all of the following steps: (a) For each conditional role, test each condition against the object in focus; (b) If every condition succeeds, the role is valid on the object in focus and made available to the user; and/or (c) The role defines the scope of privileges the user may perform, the access level defines the attributes of the object the user is able to read/write.

In step 108, the system dynamically associates the role with the actor based at least in part upon the required minimum role or the actor's selection. This is broken down into some or all of the following steps: (a) If a single role is available this is dynamically assigned to the actor; (b) If more than one role are available and an operation is passed, filter roles by those that include the required privilege (if any); (c) If only a single role is left, select that role; (d) Else if more than one role is available, prompt user for selection; and/or (e) Else if no roles are available the request is denied as no roles provide the required operation.

In step 110, if an operation is requested the system will validate the operation against the provided privileges and if valid process/authorize the request. This is broken down into some or all of the following steps: (a) Validate that the requested operation is in the list of privileges provided by the actor's associated role; (b) Validate user has remaining entitlement for the requested operation; (c) Validate request passes all policies (e.g., QoS, time, security, etc.); (d) If the operation is a read request, only return fields where the read access level is equal to or below the access level associated to the actor; (e) If the operation is a write or update request, ensure fields in the write or update request's access levels are equal to or below the access level associated to the actor; and/or (f) If all of the above are true, authorize the request.

In step 112, the system responds with the determined result which will include an authorization (allow or deny) and any necessary detail(s).

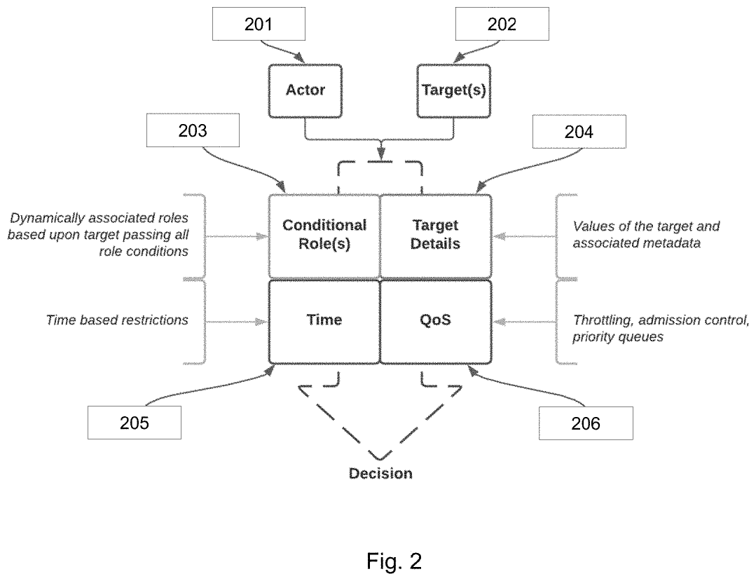

FIG. 2 shows a high-level view of this approach. Actor 201 represents the actor who the authorization is being performed for. An actor may be a user (internal or external), a service, a bot, etc. Target(s) 202 represent the object(s) that the actor is trying to perform the operation on. These target(s) are evaluated against the conditions defined by the conditional roles to determine if the actor can implement any roles which provide certain privileges.

Conditional roles 203 are composed of conditions that define rules a target (object) should match in order for a role (group of privileges) and access level are to be granted to the user. A user may have multiple available roles based at least in part upon the various conditional roles they are assigned which they can choose to implement to perform an operation. These conditions also define the access level a user has which may limit the scope of attributes they can read/write.

Target details 204 are details of the target (object) that are used as inputs to the conditions defined in the conditional roles. In order for a role to be available, the target details should match defined conditions.

Time 205 defines overrides and constraints that may limit what operations a role or actor may perform even if they have the privilege to do so. For example, a business may have restrictions that changes to certain target types are restricted during a period of time (e.g., closing of the books, etc.).

QoS (Quality of Service) 206 defines the limits an actor may have when performing operations on desired targets. Based at least in part upon restrictions and limits, the actor's operations may be throttled.

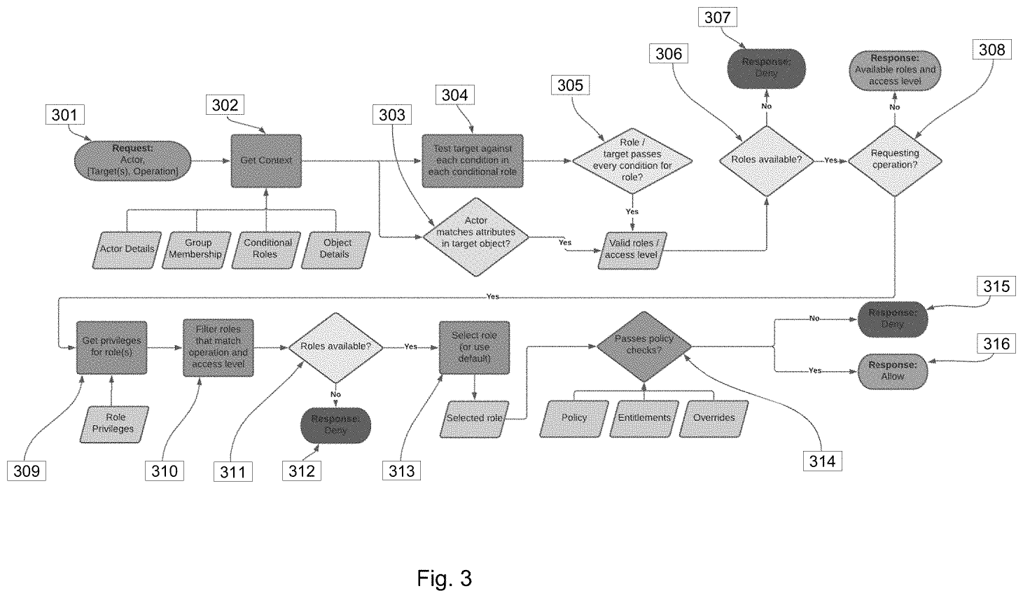

FIG. 3 shows a more detailed breakdown of the inventive approach according to some embodiments. At 301, the system receives the request. At 302, the system gathers the necessary context from various data sources which is required as inputs into the conditions. For attribute-based controls, at 303, the target and actor are compared to see if the actor may have any attributes that provide an implied role (e.g., created by, owner, etc.). In that case, an associated role for the type of attribute will be made available to the actor.

At 304, the target is tested against each condition in each conditional role for the actor. At 305, if the target meets all conditions, the role and associated access level is valid for that target and is made available to the actor.

At 306, A check is performed whether any roles are valid and available based at least in part upon the conditional checks. If none are valid as determined at 307, then the request is denied and no available roles on the target are returned. At 308, if the user is not requesting an operation and roles are available, the system will return the valid roles available to the actor on the target.

At 309, if the user is requesting an operation, the system will get the privileges for the available roles. At 310, the system will filter the roles and access levels that meet the requirements for the requested operation. At 311, this step checks if any roles are valid and available based at least in part upon the required operation and access level. If there are roles that are valid and pass the filter, the system will prompt the user to select a role to dynamically assume or use the default. At 312, if there are no roles that pass the filter, the system will deny the request.

At 313, a selection is made of the role the actor wishes to leverage in the context of the operation. This selection is only applicable to the context of this operation and there are no guarantees that the role will be available in the future given the changing nature of the target(s) or objects (e.g., an object's values may change causing it to not match previous conditions).

At 314, the system will query the policy engine to ensure all necessary policy, entitlements, overrides and/or other rules are valid. At 315, if any of the policy checks fail, the request will be denied. A 316, if all of the policy checks pass, the request will be authorized and allowed.

With regards to action visibility, when it comes to available actions, there are at least two approaches that can be taken: (1) do not show unavailable items at all; and/or (2) show items but disallow.

By way of an example approach, given that hiding things completely can cause confusion, one possible approach is to show but disallow actions. On mouse over, the system can provide a tooltip explaining why the action is unavailable. For example, the tooltip may provide “This item is currently unavailable. To access you need <ROLE XYZ> on <OBJECT A>. Your current role is <ROLE AAA>”.

The next section of this document provides some definitions of the core actors, common use cases and requirements that should be considered. Actors are entities that will interface with the policy engine and require authorization to perform certain operations. The following list provides a non-exhaustive list of examples: (a) User, such as Internal user, External user, and/or API user (token, etc.); (b) Client (app/web app); (c) Platform services, such as API Gateway, Service Mesh, Service(s), Etc.; and/or (d) 3rd party applications.

The following defines some of the terms and concepts relevant to authorization. A subset of these will be discussed in greater detail in the following sections. Authorization pertains to the act of determining (or denying) permission to perform an operation. Authorization is determined based at least in part upon a variety of factors, such as Actor, Operation, Target, Privilege(s), Entitlement(s), and/or Feature Flag(s). A privilege is a distinct operation/ability exposed as part of a feature and details what the actor can do. For example: (a) Create ticket on Entity A; (b) Create issue on Entity B; and/or (c) Add user to Org Z. An entitlement (quota) explains how much of the privilege they are entitled to. Examples include, (a) Create Ticket at 10/day; and/or (b) perform API Get:1,000/hour. A feature flag pertains to a flag that determines whether a feature is available to the user or not. The flags may be determined based upon the plan/tier of service, or access to special alpha/beta programs for testing. Examples may include: (a) FeatureFooEnabled: true; and/or (b) FeatureBarEnabled: false. A policy pertains to logic that is used to determine authorization. This may require input data to make a decision such as for example: (a) Actor (who)/Operation & Target (what); (b) Privileges (what they are privileged to do on the target); (c) Entitlements (how much they are entitled to perform); and/or (d) Environmental context. The actor may be any of a user, machine, and/or service. The actor is the entity attempting to perform the request or interfacing with the system. An actor may be a member of one or more groups/teams. An operation is a request from the actor and directly maps to one or more privileges. It should be noted that some operations may abstract multiple API calls/privileges, however will commonly be one to one. Example(s) include: (a) Read ticket; (b) Close ticket; and/or (c) Create project->create project, create n(issues). A Target pertains to the object or view the operation is being performed upon. Example(s) may include: (a) Ticket; (b) Issue; (c) Dashboard; and/or (d) Chat bot. The Environment/Context may correspond to environmental items that add context and help the system make decisions whether an operation should be performed or not. For example, though a user has a privilege to perform something you may want to enforce blackout periods or limit operations during security events, etc.

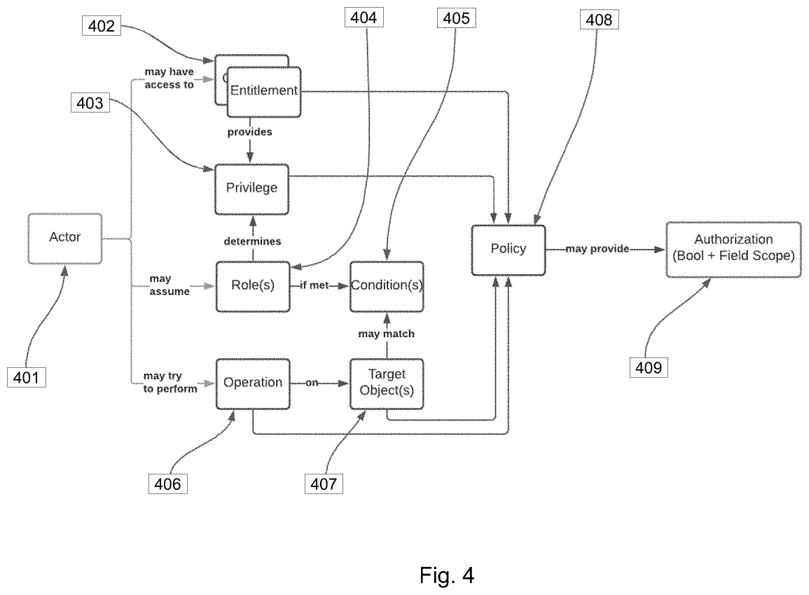

FIG. 4 shows a high-level view of some these concepts. The actor 401 represents the actor who the authorization is being performed for. An actor may be a user (internal or external), a service, a bot, etc. The entitlement 402 is the quantity of operations (quota) the actor may be entitled to perform in a set period. Privilege 403 is the right to perform an operation is a distinct type. Role(s) 404 define a bucket of privileges that the actor may perform if the target object matches the conditions defined. Condition(s) 405 define the rules that the target object(s) should match in order for the actor to inherit the role. Operation 406 is the operation the actor is requesting to perform.

Target object(s) 407 represent the object(s) the actor is trying to perform the operation on. These target(s) are evaluated against the conditions defined by the conditional roles to determine if the actor can implement any roles which provide certain privileges. The target(s) are also evaluated for attribute-based scenarios (e.g., did actor create this target object) which may provide some additional privileges.

Policy 408 defines the rules and logic to test the target matches the conditions for each conditional role providing the actor the applicable roles, checks for entitlements and ensures that no overrides (time, QoS) block the operation.

Authorization 409 is the boolean result (allow/deny) whether an actor may perform the requested operation or not. It also includes an access level which defines the attributes of the target object that an actor may read or write.

Expanding on the foundational concepts discussed above, there are some building blocks that can be used to complete the picture. For example, the concept of a group (which may also be referred to herein as a team) can be represented as “[ ]{object:role}+[ ]actors (users, etc.)+[ ]group (includes)”. Groups are a mechanism to combine relevant object:role mappings together and simplify actor management. By default, some embodiments implement a group for all actors which has a default role in an organization. Groups may also include other groups.

A tier may correspond to {actor/org:tier}, where a tier group re-uses the group construct for application of tier levels and/or feature entitlements. A tier group would be defined for each level of service and an actor should belong to a single tier group. A tier for a product could be packaged as part of a plan which could include multiple tier groups across products.

A role may correspond to [ ]privilege+[ ]roles (includes), where a role defines the common features and associated privileges needed by someone in the role to perform their job duty. A role includes a collection of privileges which can be enabled/disabled as a whole. While a privilege may be mapped to a role, it will be enabled/disabled depending on whether or not the feature or entitlement has been purchased. Upon purchase the new feature would then just be flipped to an enabled status. Roles by themselves are not mapped directly to actors, they are conditionally mapped using conditional roles.

A condition is the criteria that should be met for the role to be applicable to the object(s). For example, a support engineer manager may have the role ‘Admin’ when the condition is met for “object_type==‘work’ AND work category==‘ticket’ AND entity.category==‘entity category foo”’. In contrast, a tech lead may have the role ‘Admin’ when “object_type==‘work’ AND work category IN [‘ticket’,‘issue’] AND entity.category==‘entity category bar’”

By defining conditions, the system can provide a significant amount of granularity and control over the system. Essentially, the condition becomes equivalent to the contents of a WHERE statement. By doing so, the system can reuse the roles without having to create dedicated roles for each job function. Instead, the job function specific detail becomes integrated into the condition.

A Conditional Role corresponds to {condition:role:access_level}, where a conditional role is applied assuming the conditions are met. An actor may inherit a conditional role via a group. Roles may be defined (via conditional role tuple) or inferred based at least in part upon attributes (e.g., owner).

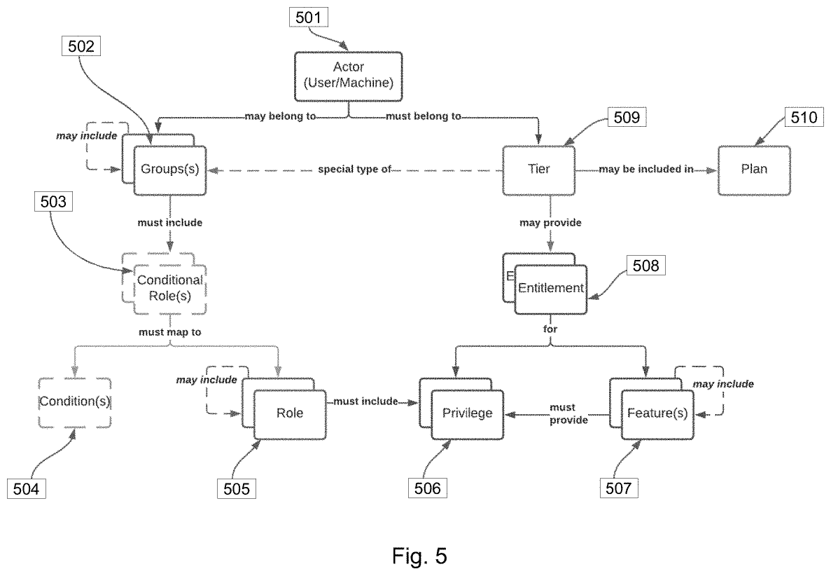

FIG. 5 shows a relationship from an actor to roles on object(s) and entitlements they may have. Actor 501 represents the actor who the authorization is being performed for. An actor may be a user (internal or external), a service, a bot, etc. Groups 502 define a collection of conditional roles and actors. Actors may be a member of 0 or more groups which define the conditional roles and indirectly scope of objects/operations they may perform. Conditional roles 503 defines a set of conditions and the role and access level made available if the conditions evaluate to true for the target object. Conditions 504 represents conditions in the system. A role 505 defines a collection of privileges which give the actor the ability to perform certain operations. A privilege 506 is the distinct operation exposed by an interface. These may be API operations, etc. An entitlement 508 is the quantity of operations the actor may be entitled to perform in a set period. Features 507 define a bucket of privileges/operations exposed which may be enabled/disabled via flags on a per tenant basis. A tier 509 defines the level of service the actor has which may provide certain entitlements/feature flags/abilities. Plans 510 may include multiple tiers across different products.

Roles are a critical construct to ensure an actor can get the correct privileges on the correct items. Rather than mapping individual privileges to users, it is desirable to bucket these across features into roles which define the privileges necessary to perform the role.

Roles can be determined in at least two core ways, either by being defined or being implied. With regards to defined roles, these roles are those that are explicitly stated and maps to and object via a Conditional Role (e.g., which can be added to a group). These define the conditions an object and actor must meet in order for the role to be dynamically available to the actor. These are most similar to the traditional RBAC style approach that is used to give a role to a user. However, instead of being statically mapped, the roles are assigned dynamically based upon the conditions an object must meet in order for the role to be available. As objects change and evolve a role may become available or unavailable.

With regards to implied roles, these roles are those determined based at least in part upon attributes of the object. For example, the owner role may be implied based at least in part upon who's the owner, similarly for things like creator (created by), watcher (watched by), approver (approved by), etc.

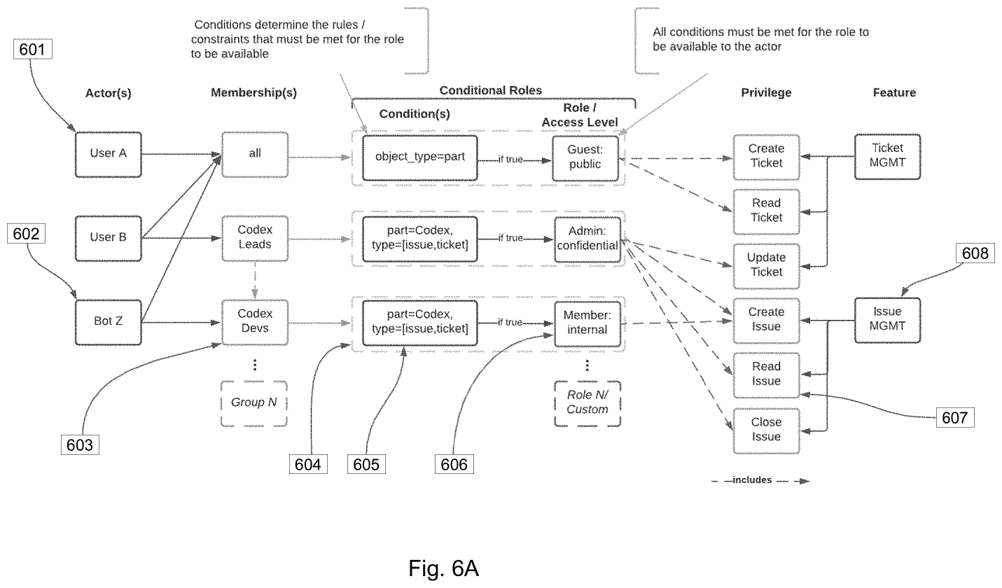

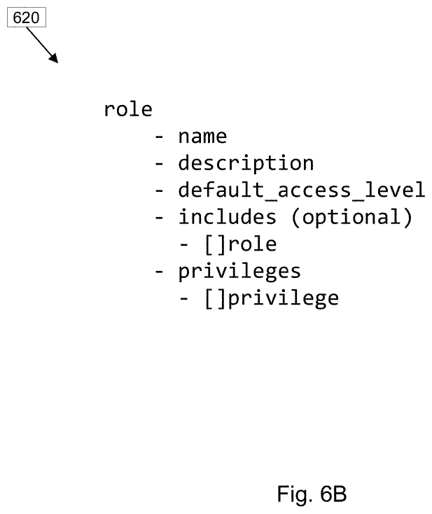

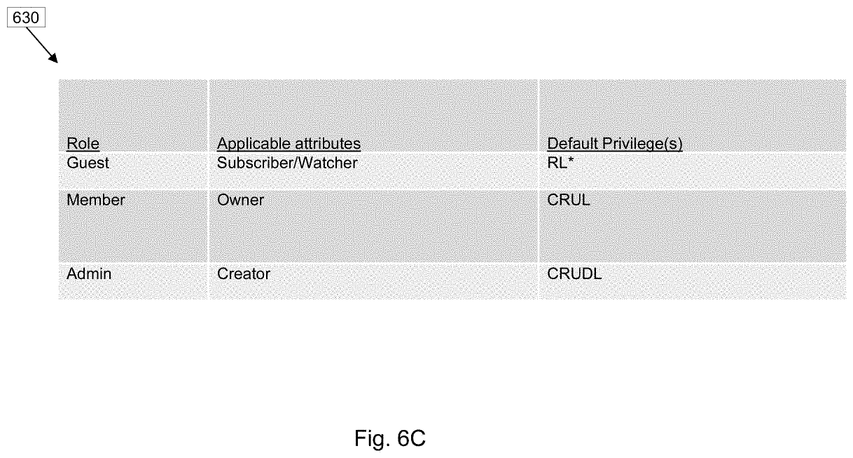

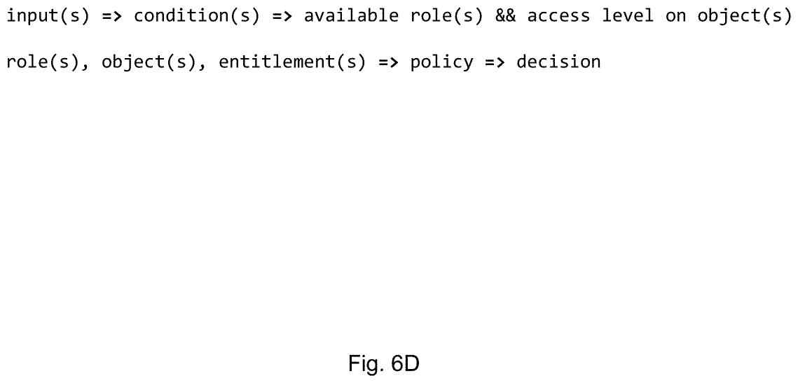

FIG. 6A shows the relationship between a feature (part), the privileges it provides, how those may be teamed with a role and mapped to object roles. At 601, the Actor represents the actor who the authorization is being performed for. An actor may be a user (internal or external), a service, a bot, etc. In this example two sample users (User A and User B) are shown. Bot Z 602 represents an example non-human user that may be requesting operations like another user or on behalf of a user.

Memberships 603 define a collection of conditional roles and actors. Actors may be a member of 0 or more groups which define the conditional roles and indirectly scope of objects/operations they may perform.

Conditional roles 604 define a set of conditions, and the role and access level made available if the conditions evaluate to true for the target object. Conditions 605 are rules that the target object(s) are evaluated against, and if true, the role is granted. Conditions 605 define a series of conditions (rules) that the target and actor object should meet. A role 606 defines a collection of privileges which give the actor the ability to perform certain operations. Roles may include other roles.

A privilege 607 is the distinct operation exposed by a service or feature provided by a service. These may be API operations, activities, object operations, etc. Feature(s) 608 define a bucket of privileges/operations exposed which may be enabled/disabled via flags.

The roles here would correspond to job functions which an actor would perform (e.g., triager which triages tickets on a part, handled issue assignment, etc). Roles allow the system to bucket privileges together into common operations/privileges that would commonly go together. This helps simplify things by grouping privileges into common operations which can then be further bucketed into common functions.

A role will be mapped to an object which will serve as a “namespace” for the role and may be interpreted in various ways.

For example, a role on an entity would translate to that role on all objects linked to that entity (e.g., ticket linked to entity A). A role on a project would translate just in the scope of the project which may contain work linked to various parts but would not give them roles on the associated work items unless they had defined roles in the entity the work was linked to as well.

Certain ‘roles’ may be implied based at least in part upon object attributes. For example, the creator of a comment would have the ‘creator’ or ‘owner’ role on the comment and be allowed to perform certain operations, others may not. The structure 620 shown in FIG. 6B can be used to define a sample role structure.

The following are pre-defined (stock) roles that should cover most common use cases. Each of these roles will have default mappings to privileges (actions) which can then be mapped to targets(entities) and scopes (e.g., single customer, all customers, an organization, etc.).

A user may have different roles based at least in part upon specific context. For example, a user may be an owner on a single entity (e.g., entity A), but if they do not have a role on another entity (e.g., entity B) they may be considered a member in the context of entity B. The user has no role by default, based at least in part upon the object the user is trying to interact with, and the conditions defined, if the object meets the conditions the user will assume the role defined.

Numerous possible roles and definitions may be used in embodiments of the invention. For example, a Guest (stakeholder) is a role where the guest is a user who is a stakeholder in the context of the object. In an organization, a user may be a guest, similarly a customer is also a stakeholder or guest. A guest will include stock privileges like the ability to create tickets, view their created tickets, etc. Guest roles can also be given on specific objects like an issue or ticket where the guest can read the object details (fields may be limited).

As another example, a Member (doer) role corresponds to a person responsible for owning the object and any work which may be necessary. In the support engineer scenario above the support engineer manager would triage the tickets and assign to a support engineer which would own the ticket and perform work on it. This also applies to things that are created in the context of another object. For example, the creator of a comment would be an owner of the comment and thus have certain privileges. A member on an entity (aka developer) would have the ability to create issues on their entity.

An Admin (gatekeeper) role corresponds to an admin (triager) role that exists between the front-office (member->employees, customers, etc.) and back-office (owner->developers, etc.). They act as an abstraction and gatekeeper triaging incoming requests(s) for their associated objects and determining which ones to “accept” and allocate to people who will perform the activity (could be themselves). Upon “accepting” they or the system would then allocate the object(s) (e.g., ticket or issue, etc.) to a user's queue who would become the owner of the object. For example, a support engineer manager would triage tickets and assign to support engineers, similarly a Team lead would triage requests and potentially create and assign issues to developers on their team.

There are also some additional roles based at least in part upon attributes. For example, a Creator role corresponds to the creator of the object. An Owner role corresponds to the owner of an object may get specific elevated privileges. A Subscriber/watcher role is where a subscriber is equivalent to someone who is watching a thread or object, when someone “subscribes” to something they automatically become a guest on that object.

The table 630 shown in FIG. 6C shows how these roles may map to default privileges (high-level) in some embodiments of the invention.

In some embodiments, a guest role can still create tickets on any part that they are a guest on. In addition, in some embodiments, there is no need to differentiate between internal and external users with a role. However, there are scenarios where one may have individuals such as developers who would like to see the work (issues) other developers are working on, or tickets related to their parts. This is where the application of roles to “scopes” is important. In the “general user” scenario, they would just be a member of their org which gave them minimal privileges (e.g., create ticket, view tickets they created, etc.).

To give someone like a developer access to issues related to parts in the system, the system can assign the role to an object (scope). In that scenario the system could give them the member role on any (*) object which gave them read access, or could restrict to objects linked to specific parts (e.g., entity A, entity B, etc.)

With regards to role scoping, the ability to map roles to specific object(s) in the system is important—which is contrary to the traditional idea of “global” roles. In the current context mapping of a user to object(s) with specific roles is critical for the user experience, available operations and ensuring the triaging workflow can be adhered to. In order to do this, the system maps a user's roles to specific object(s) (via a group). This allows them to have elevated permissions on some, however, reduced permissions on others to aid in noise avoidance.

For example, traditionally users would be able to file issues directly against another user's service or component. This was typically ungated and lead to the following: (a) lots of duplicate issues; (b) invalid issues being filed; (c) noise and context switching with the developer.

One goal is to eliminate this noise and context switching by only allowing users who work on the entity (object) to file issues on it provided by privileges they inherit via a role (e.g., owner). All others would have to file tickets which would then be triaged and either accepted or rejected by those holding the triager role on the entity (object) the ticket was filed against.

To make this assignment manageable, the system can abstract this with “group”. Groups are a mapping of conditional roles. Groups can inherit from other group and a user can be part of multiple groups. This allows the system to define a group which contains n conditional role tuples and add users to that group vs. adding on each individual part.

Conditions can be used to set both the applicable role, access level, and available object types, e.g., as shown in FIG. 6D. For example, when a customer creates a ticket, they are the “creator” of that ticket which gives them an “admin” role and the ability to close/delete that ticket. However, their access level would be set to public as they are a customer and should not have access to internal data like assignment, priority, tags, internal metrics, etc. A support engineer on the other hand may be a “member” on that ticket, but have access to internal fields giving them access to that information. If any financial or sensitive information is included, the system may want to determine who can see even at the member level. In that scenario, attributes of the internal user like level (e.g., VP, etc.) could provide an elevated access level even though their role is still set to member.

As an additional example, if the system starts tracking opportunities for product led growth one could have conditional logic where anyone who is a member on the object/linked items could see the opportunity value up to a limit. For example, say an inside sales rep could see the opportunity amount if it is <=$100 k. For amounts>$100 k, only managers or the sales leadership may be able to see. In the same scenario, the support engineer may be able to see that there are opportunities for the customer who opened a ticket, but should not be able to see the amount(s).

By leveraging conditions to define and determine roles and access levels the system provides for a great deal of flexibility and control.

There are numerous possible condition types that may be used in embodiments of the invention. Non-limiting examples of condition types include: (A) Comparison, such as (a1) Equality, where the operation(s) are “equal to: =, ==”, and example(s) may include “object.work_category=issue”, and/or (a2) Inequality, where the operation are “Not equal to: !=”, and example(s) may include “object.work_type !=bug”; (B) Number comparison, where the operations may include (b1) Greater than: >; (b2) Greater than or equal to: >=; (b3) Less than: <; and/or (b4) Less than or equal to: <=, and example(s) may include “object.value>100”; (C) Range, where the operation(s) may include “Between: BETWEEN”, and example(s) may include “object.value BETWEEN 1000 AND 2000”; (D) Logical, where the operation may include: (d1) Negation: NOT; (d2) Conjunction: AND, &&; and/or (d3) Disjunction: OR, ∥; and example(s) include “object.work_type==“ticket” AND object.created_by_id=“foo.bar””; and (E) Regular expression, where the operation may include “Like: REGEXP LIKE<REGEX>”, and example(s) include “WHERE REGEXP_LIKE (first_name, ‘\hat{ }Ste(v|ph)en$’)”.

It should be noted that compound conditions may be employed, where the compound conditions combine multiple conditions together logical operations (e.g., AND, OR, NOT)

Privileges are a foundational component of the current authorization solution, where a privilege essentially defines an operation that can be invoked and should be measurable. A feature may expose multiple privileges which may correspond to the abilities (via operations) it provides. It is not a safe assumption that every type of user in the system should get access to all privileges a feature provides and thus authorization should be handled at the privilege level compared to feature.

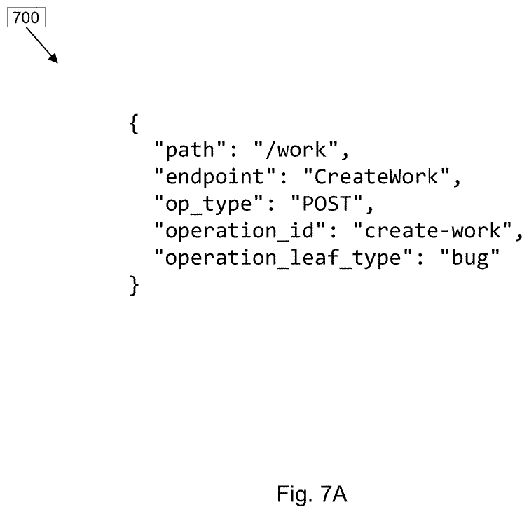

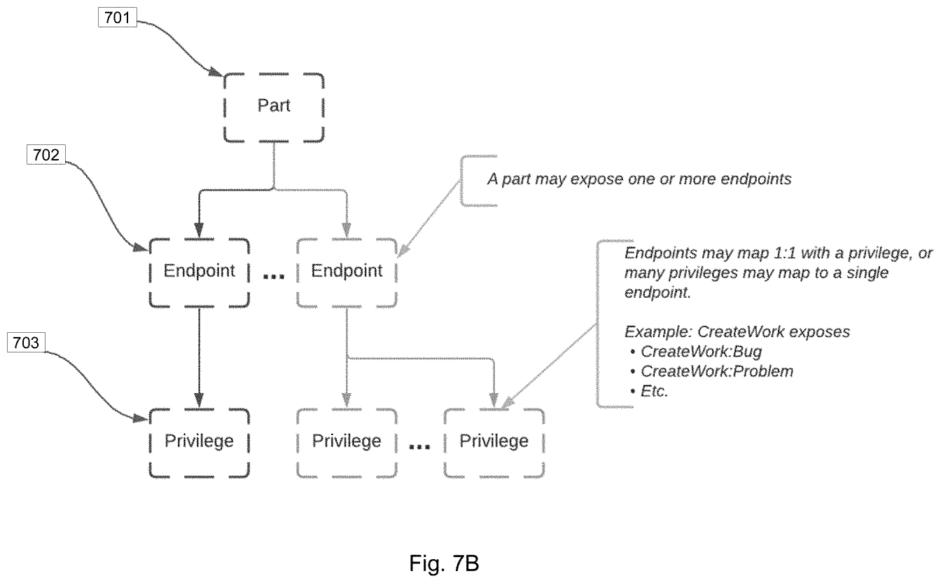

The invention includes functionality that determines privileges for a feature/part. To determine what privileges are exposed/provided by a part in the system, it starts with the endpoints/interfaces they expose. FIG. 7A shows a sample privilege schema 700.

With regards to endpoint-to-privilege mappings, depending on how the endpoint (API/RPC) is structured, it will align with privileges in possibly one of the following ways: (a) Privilege maps directly to endpoint (Example: Create Comment (privilege)=>CreateComment (endpoint)); (b) Multiple privileges map to a single endpoint (Example: (i) Create bug (privilege)=>CreateWork (endpoint)=>request inspection=>type:bug; (ii) Create problem (privilege)=>CreateWork (endpoint)=>request inspection=>type:problem).

FIG. 7B shows an example endpoint to privilege structure. Here, a part 701 (entity) is any related piece of a product or service. This may be a product, capability, feature, or service. The endpoints 702 are API endpoints that may expose one or more operations which correspond to a privilege. A privilege 703 is the distinct operation exposed by an interface. These may be API operations, etc.

These endpoints may be internal (e.g., exposed by an internal service, microservice, etc) or externally facing (via API gateway). For service-to-service AuthZ, these RPC (remote procedure call) endpoints will be used to determine privileges which can be given to services as necessary.

A timeline may correspond to endpoints, including for example, comments and reactions. For comments (feature), this may include: (a) Create=>CreateComment( ) (b) Read=>GetComment( ) (c) Update=>UpdateComment( ) (d) Delete=>DeleteComment( ) and/or (e) List=>ListComments( ) For reactions (feature), this may include: (a) Create=>AddPin( ) (b) Read; (c) Update; (d) Delete=>RemovePin( ) and/or (e) List. In the above example, these would map one to one with a privilege and thus can be simply mapped.

However, if work management is considered as an example, then it may expose the following endpoints: (a) CreateWork( ) (b) GetWorkO; (c) UpdateWork( ) (d) TransformWorkO; (e) DeleteWork( ); (f) ListWorks( ).

The actual privileges may be more granular than the endpoint so this follows an additional structure where the endpoint does not map one to one with a privilege and a further request inspection is needed. In this scenario, the request body is inspected and details about the request are used to determine the type of work being requested. Privileges would map N:1 with the endpoint (CreateWork), and 1:1 with the WorkTypeValue(s) which map 1:1 with the work object types and internal interfaces (e.g., toCreateProblemO).

This paragraph describes an example of how this would map for certain work (capability). For Ticket Management (feature), this may include: (a) Create=>CreateWork( )=>“toCreateProblem( )”, “toCreateRequest( )”, and/or “toCreateFeedback( )”; (b) Read=>GetWork( ); (c) Update=>UpdateWork( ); (d) Delete=>DeleteWork( ); and/or (e) List=>LetWorks( ). For Issue Management, this may include: (a) Create=>CreateWork( )=>“toCreateBug( )”, “toCreateEnhancement( )”, and/or toCreateNewPart( ); (b) Read=>GetWork( ); (c) Update=>UpdateWork( ); (d) Delete=>DeleteWork( ); and/or (e) List=>LetWorks( ).

With regards to attribute-level access, while privileges control the operations and objects, operations can be performed if there is a need for further granularity. For example, on a customer ticket, there may be internal commenting for the ticket, and one may commonly want those comments to be private to the support engineers or internal employees working on the ticket. By default, those comments could be marked “private” and thus only visible to the users that have that access level. When marking a message as “public,” this would allow the customer to see the comment.

When storing sensitive items (such as opportunities, accounts, or any financial data), it is important to ensure only certain people can get access to those fields/attributes. The system may allow special users to view an opportunity, but only if they had elevated privileges would they be allowed to see the sensitive fields.

Example access classifications may include Public, Internal, Confidential, and Restricted classifications. The classification for Public may correspond to fields that anyone with access to the object can see. Example fields may include Title, Body, created-by-date, and/or created-by-fields. This may be used as a default for certain roles, such as for a Guest role. The classification for Internal may correspond to fields that anyone with elevated access to the object can see. Example fields may include Priority, Tags, and/or Owner. This may be used as a default for certain roles, such as for a Member role. The classification for Confidential may correspond to fields that anyone with elevated access to the object can see. Example fields may include PII data and/or financial data. This may be used as a default for certain roles, such as for an Admin role. The classification for Restricted may correspond to fields that are sensitive in nature and only specific people should be able to see. Example fields may include secret data.

In some embodiments, these field access levels will be used in coordination with the following calls: (a) Get (what fields are returned); (b) Create (what fields can be set); and/or (c) Update (what fields can be set). In some embodiments, if a user has the privilege to update an object, the fields they can update will be determined by their access level.

When a user wishes to add a custom field to an object, the system may request to provide a visibility level for this field. For example, a new field would intake the following inputs: (a) name: The name of the field; (b) display_name: The display_name of the field (used in UI); (c) type: The type of the field (e.g., string, enum, etc.); (d) visibility: The visibility of the field (e.g., public, internal, confidential, restricted).

For a role, this has default visibility level, e.g., Customer=>Public, Developer=>Internal. A default visibility can be overridden with an enhanced visibility on certain object types via privileges.

When it comes to defining the logic to handle authorization, a rule/policy engine can be employed to perform this functionality. The rule/policy engine can enforce policy decisions throughout the stack (client (external)->edge->gateway->service (origin)). The engine may decouple policy and data used as input to the policy.

The engine is broken down into a few core areas, including its input data (e.g., in the JSON format), the policy logic definition, a compiled policy, and its output data (e.g., JSON). By design the data is kept outside of the policy as it can be assumed that data can be in constant flux however policies can be relatively consistent. This allows privileges and entitlements to be very dynamic.

For example, if the system has defined a policy in the following way [IF operation IN user.privileges AND user.has_entitlement=>ALLOW], then if new privileges are added which correspond to operations in the front end, the policy would just continue to work without any updates. This allows the system to be very flexible and update privileges/functionality at a rapid pace without requiring frequent updates to the policy.

A policy definition language may be employed to allow users to define logic and output results. The policy definition language packages logic into rules which allow a rule to be defined then reused. Multiple types of rules may be used. A “complete rule” assigns a single value to a variable (e.g., allow=true). A “partial rule” returns a set of values to a variable (e.g., privileges j son). Everything within the rule can evaluate to true for the rule to return a result (Logical AND). To facilitate a Logical OR, one can define the rules N times with different logic and as long as one returns a good result it will return as true.

Enforcement corresponds to ensuring that an actor can only do what they are authorized to do. Enforcement can occur in a few core places: (a) Client; (b) Edge/CDN; (c) API Gateway; (d) Service.

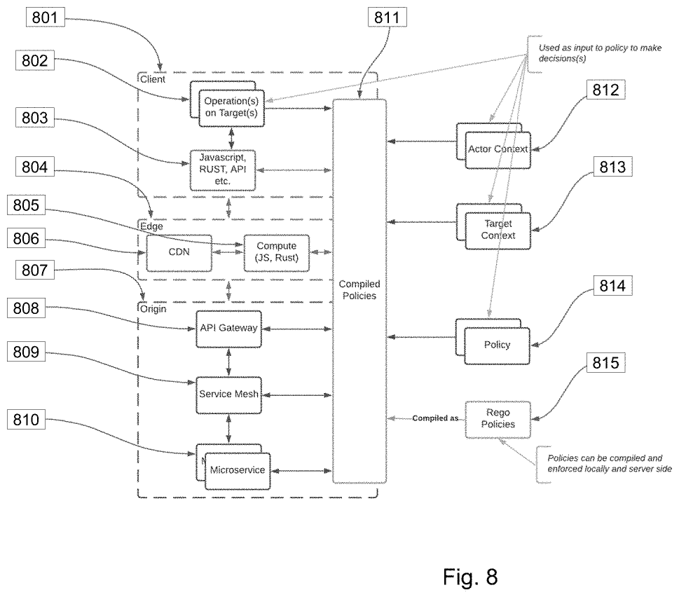

FIG. 8 shows an example approach to implement a policy/rule engine. This approach shows how policy enforcement is critical from the client to the edge to the origin. A Client 801 corresponds to an external client that may be a browser-based application, mobile application, or API consumer. At 802, the client will be requesting to perform operation(s) (e.g., read, write) on target(s) (distinct objects). At 803, a variety of tools on the client side may be used to query policies. For example, programming languages like RUST, Javascript, etc.

Edge 804 refers to points-of-presence which are close to the client and can provide a subset of services. Examples of these are content distribution/delivery networks (CDN) or other forward-deployed instances placed close to the client. Compute 805 refers to processing entities that can execute certain operations and interact with the policy. These may call into a CDN to fetch cached data. A CDN 806 is used to cache static content and API responses. Origin 807 refers to where the primary services providing the service are hosted. These may be in a cloud or on-premise datacenter. API gateway 808 refers to the gatekeeper handling requests from the external world.

The service mesh 809 refers to the control plane controlling traffic between entities. Microservice 810 refers to the individual services providing some of the functionality.

Compiled policies 811 refer to the logic and policy which is compiled and leverage through the various tiers (client, edge, origin). Actor 812 context refers to details about the actor. Target context 813 refers to the details about the target (e.g., object). Policy 814 refers to the human readable policy defining generic rules. Policies 815 define the distinct rules.

In some embodiments, the policy can be compiled to portable self-contained package (e.g., WebAssembly (WASM)) for distribution. This allows the compiled policy to actually be loaded by the client or edge service and queried locally for policy/rule decisions. Traditionally the client or edge service would need to query the API gateway or a service to get the users privileges and/or make decisions. By loading the policy locally, the client or edge service can focus on pulling the content (e.g., body of work or part, etc.) and can query the local policy service as to what should be available vs. disabled. This will also minimize the number of invalid requests handled by the API gateway as they can be blocked at the client.

Therefore, what has been described is an approach for dynamically applying roles and access levels to an actor based at least in part upon a set of conditions an object should meet for the role to be assumed. Some embodiments may be used to dynamically determine privileges based at least in part upon API endpoints and operations. A multi-factor approach can be taken for determining authorization based at least in part upon conditions, attributes, and policy.

### Illustrative Computing System Overview

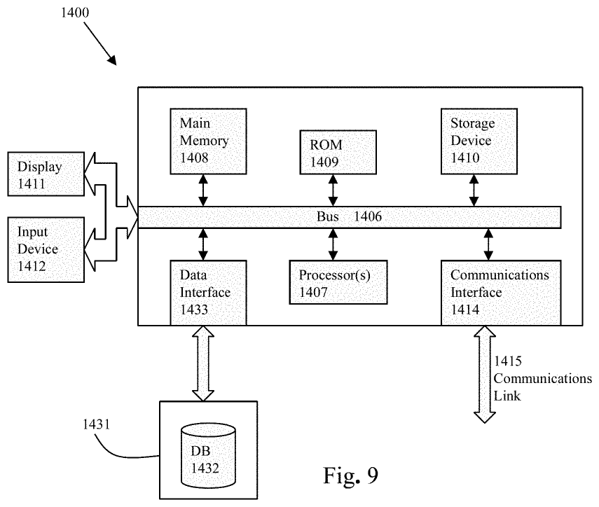

FIG. 9 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408. A database 1432 may be accessed in a computer readable medium 1431 using a data interface 1433.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

We claim:

1. A computer implemented method, comprising:
receiving a request for access to an object in a computing system by an actor;
dynamically applying a role and an access level to the actor; and
providing access to the object in the computing system based at least in part upon the role and the access level that was dynamically applied to the actor.

2. The method of claim 1, wherein the role and the access level are dynamically applied to the actor using a multi-factor approach based at least in part upon conditions, attributes and policies corresponding to the object and/or the actor.

3. The method of claim 1, wherein the role and the access level are dynamically applied to the actor based at least in part upon a set of conditions that are met by the object and the actor for the role.

4. The method of claim 1, wherein a set of privileged are granted to the actor for the object that correspond to the role and the access level.

5. The method of claim 4, wherein the set of privileged are dynamically determined based at least in part upon feature flags, API endpoints and operations.

6. The method of claim 1, wherein real-time events are considered as inputs to dynamically determine the role and/or the access level.

7. The method of claim 1, wherein each of the object and the actor are tested against a condition in a conditional role.

8. A computer program product comprising a non-transitory computer accessible medium storing thereupon a sequence of instructions which, when executed by a processor, causes the processor to perform a set of acts comprising:
receiving a request for access to an object in a computing system by an actor;
dynamically applying a role and an access level to the actor; and
providing access to the object in the computing system based at least in part upon the role and the access level that was dynamically applied to the actor.

9. The computer program product of claim 8, wherein the role and the access level are dynamically applied to the actor using a multi-factor approach based at least in part upon conditions, attributes and policies corresponding to the object and/or the actor.

10. The computer program product of claim 8, wherein the role and the access level are dynamically applied to the actor based at least in part upon a set of conditions that are met by the object and the actor for the role.

11. The computer program product of claim 8, wherein a set of privileged are granted to the actor for the object that correspond to the role and the access level.

12. The computer program product of claim 11, wherein the set of privileged are dynamically determined based at least in part upon feature flags, API endpoints and operations.

13. The computer program product of claim 8, wherein real-time events are considered as inputs to dynamically determine the role and/or the access level.

14. The computer program product of claim 8, wherein each of the object and the actor are tested against a condition in a conditional role.

15. A system for implementing a standby database, comprising:
a processor;
a memory having stored thereupon a sequence of instructions of program code, which when executed by the processor, causes the processor to execute a set of acts comprising: receiving a request for access to an object in a computing system by an actor; dynamically applying a role and an access level to the actor; and providing access to the object in the computing system based at least in part upon the role and the access level that was dynamically applied to the actor.

16. The system of claim 15, wherein the role and the access level are dynamically applied to the actor using a multi-factor approach based at least in part upon conditions, attributes and policies corresponding to the object and/or the actor.

17. The system of claim 15, wherein the role and the access level are dynamically applied to the actor based at least in part upon a set of conditions that are met by the object and the actor for the role.

18. The system of claim 15, wherein a set of privileged are granted to the actor for the object that correspond to the role and the access level.

19. The system of claim 18, wherein the set of privileged are dynamically determined based at least in part upon feature flags, API endpoints and operations.

20. The system of claim 15, wherein real-time events are considered as inputs to dynamically determine the role and/or the access level.

21. The system of claim 15, wherein each of the object and the actor are tested against a condition in a conditional role.
